(19) United States
(12) Patent Application Publication
(10) Pub. No.: US 2019/0217674 A1
(43) Pub. Date: Jul. 18, 2019

(54) MULTI-VEHICLE ARTICULATION ANGLE SENSING ARRANGEMENT

(71) Applicant: SAF-HOLLAND, Inc., Muskegon, MI (US)

(72) Inventor: Randy L. Schutt, Holland, MI (US)

(21) Appl. No.: 16/246,037

(22) Filed: Jan. 11, 2019

Related U.S. Application Data
(60) Provisional application No. 62/617,812, filed on Jan. 16, 2018.

(51) Int. Cl. B60D 1/30

(52) U.S. Cl. CPC B60D 1/30

(57) ABSTRACT

A vehicle system includes a first vehicle having a first longitudinal axis, a second vehicle coupled with the first vehicle and having a second longitudinal axis, and a controller arrangement that includes a global positioning system receiver, a sensor arrangement including a first sensor connected with the first vehicle and operably coupled with the receiver, the first sensor configured to sense a relative orientation of the first longitudinal axis within a global coordinate system, and a second sensor connected with the second vehicle and operably coupled with the receiver, the second sensor configured to sense a relative orientation of the second longitudinal axis within a global coordinate system, and a controller operably coupled with the receiver, the first sensor and the second sensor, wherein the controller is configured to calculate an angular offset between the first and second longitudinal axes.

### CROSS-REFERENCE TO RELATED APPLICATIONS

This application claims the benefit of U.S. Provisional Patent Application No. 62/617,812, filed on Jan. 16, 2018, entitled “MULTI-VEHICLE ARTICULATION ANGLE SENSING ARRANGEMENT,” the entire disclosure of which is incorporated herein by reference.

### BACKGROUND

The embodiments as disclosed herein relate to a vehicle control system configured to monitor the relative orientation between a towing vehicle and a towed vehicle, and in particular to utilizing GPS sensors for determining the relative orientation of a longitudinal axis of the vehicles within a global coordinate system to determine an angular offset between the longitudinal axes of those vehicles.

### BRIEF SUMMARY

One embodiment includes a vehicle system that includes a first vehicle having a first longitudinal axis, and a second vehicle operably coupled with the first vehicle and having a second longitudinal axis, wherein the second longitudinal axis of the second vehicle is movable between a first position where the second axis is aligned with the first axis and a second position where the second axis is angularly offset from the first axis. The embodiment further includes a controller arrangement that includes a global positioning system receiver, a sensor arrangement including a first sensor connected with the first vehicle and operably coupled with the receiver, the first sensor configured to sense a relative orientation of the first longitudinal axis within a global coordinate system, and a second sensor connected with the second vehicle and operably coupled with the receiver, the second sensor configured to sense a relative orientation of the second longitudinal axis within a global coordinate system, and a controller operably coupled with the first sensor and the second sensor, wherein the controller is configured to calculate an angular offset between the first and second longitudinal axes.

Another embodiment includes a vehicle system that includes a towing vehicle having a first longitudinal axis, and a first towed vehicle pivotably coupled with the towing vehicle and having a second longitudinal axis, wherein the second longitudinal axis of the first towed vehicle is movable between a first position where the second axis is aligned with the first axis and a second position where the second axis is angularly offset from the first axis. The embodiment further includes a controller arrangement including a global positioning system receiver, a sensor arrangement including a first sensor connected with the towing vehicle and operably coupled with the receiver, the first sensor configured to sense a relative orientation of the first longitudinal axis within a global coordinate system, and a second sensor connected with the first towed vehicle and operably coupled with the receiver, the second sensor configured to sense a relative orientation of the second longitudinal axis within a global coordinate system, and a controller operably coupled with the first sensor and the second sensor, wherein the controller is configured to calculate an angular offset between the first and second longitudinal axes in a substantially lateral direction.

Still another embodiment includes a method for controlling vehicle system that includes providing a first vehicle having a first longitudinal axis, and providing a second vehicle operably coupled with the first vehicle and having a second longitudinal axis, wherein the second longitudinal axis of the second vehicle is movable between a first position where the second axis is aligned with the first axis and a second position where the second axis is angularly offset from the first axis. The method further includes providing a controller arrangement that includes a global positioning system receiver, a sensor arrangement that includes a first sensor connected with the first vehicle and operably coupled with the receiver, the first sensor configured to sense a relative orientation of the first longitudinal axis within a global coordinate system, and a second sensor connected with the second vehicle and operably coupled with the receiver, the second sensor configured to sense a relative orientation of the second longitudinal axis within a global coordinate system, and a controller operably coupled with the first sensor and the second sensor, wherein the controller is configured to calculate an angular offset between the first and second longitudinal axes. The method still further includes operating the first vehicle such that the first longitudinal axis is angularly offset from the second longitudinal axis, sensing the orientation of the first longitudinal axis within the global coordinate system, communicating the orientation of the first longitudinal axis with the controller, sensing the orientation of the second longitudinal axis within the global coordinate system, communicating the orientation of second longitudinal axis with the controller, and calculating the angular offset between the first and second axes with the controller.

The principal objects of the embodiments as disclosed herein are to provide an accurate and reliable system for monitoring the relative positions between a towing and a towed vehicle allowing for calculation of forces exchanged between the vehicles, dynamic modeling and accident reconstruction, autonomous vehicle operation in both forward and rearward directions, and for dynamic control of suspension and braking units associated with the vehicles.

These and other advantages of the embodiments as disclosed herein will be further understood and appreciated by those skilled in the art by reference to the following written specification, claims and appended drawings.

### BRIEF DESCRIPTION OF THE DRAWINGS

FIG. 1 is a perspective view of a vehicle system;

FIG. 2 is a schematic top plan view of the vehicle system; and

FIGS. 3A-3G are various configurations of the vehicle system.

### DETAILED DESCRIPTION OF THE PREFERRED EMBODIMENTS

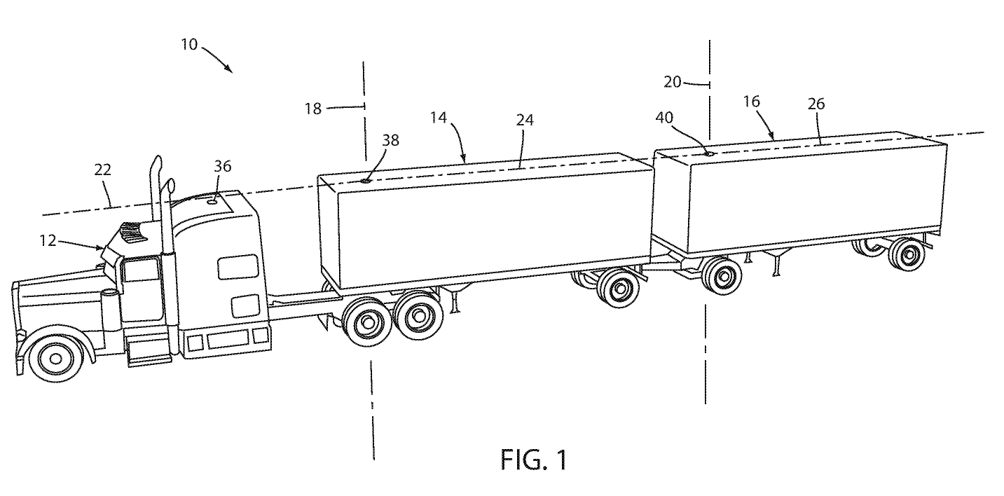

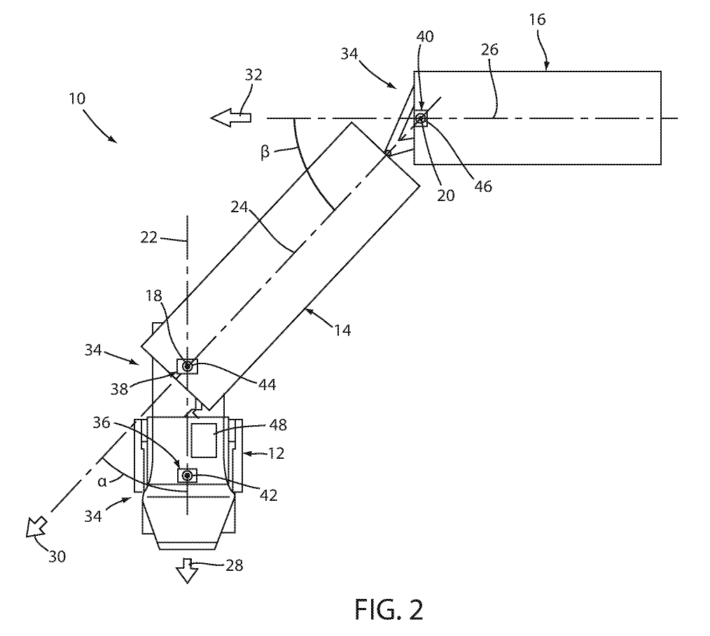

For purposes of description herein, the terms “upper,” “lower,” “right,” “left,” “rear,” “front,” “vertical,” “horizontal,” and the embodiments thereof shall relate to the invention as oriented in FIGS. 1 and 2. However, it is to be understood that the various embodiments as shown and described herein may assume various alternative orientations, except where expressly specified to the contrary. It is also to be understood that the specific devices and processes illustrated in the attached drawings, and described in the following specification are simply exemplary embodiments of the concepts defined in the appended claims. Hence, specific dimensions and other characteristics relating to the embodiments disclosed herein are not to be considered as limiting, unless the claims expressly state otherwise.

The reference numeral 10 (FIG. 1) generally designates a vehicle system comprising a heavy-duty tractor and trailer combination, wherein a towing vehicle 12 is represented by a semi-truck or tractor which operationally supports a first towed vehicle 14 represented by a first or lead trailer that in turn operationally supports a second towed vehicle 16 represented by a second or trailing trailer 16. In the illustrated example, the first towed vehicle 14 is operably coupled to the towing vehicle 12 via a fifth wheel hitch assembly (not shown) in a manner as well known in the art for pivoting about a substantially vertical first pivot axis 18, while the second towed vehicle 16 is operably coupled to the first towed vehicle via a second fifth wheel hitch assembly (not shown) in a manner as well known in the art for pivoting about a substantially vertical second pivot axis 20.

A central longitudinal axis 22 (FIGS. 1 and 2) extends along the length of the towing vehicle 12, a centrally located longitudinal axis 24 extends along the length of the first towed vehicle 14, and a centrally located longitudinal axis 26 extends along the length of the second towed vehicle 16. The longitudinal axis 22 is the path or course along the ground that the respective vehicle will follow during travel unless external forces are exerted thereon. In the illustrated example, the path or course of the towing vehicle 12 is along a direction 28, the path or course of the first towed vehicle 14 is in a direction 30, and the path or course of the second towed vehicle 16 is in a direction 32.

The vehicle system 10 further includes a controller arrangement 34 that includes a sensor arrangement comprising a first sensor 36 connected to the towing vehicle 12, a second sensor 38 connected to the first towed vehicle 14, and third sensor 40 connected to the second towed vehicle 16. In the illustrated example, the first sensor 36 is positioned along the longitudinal axis 22 of the towing vehicle 12, the second sensor 38 is positioned proximate a forward end of the first towed vehicle 14, along the longitudinal axis 24 and along the first pivot axis 18, while the third sensor 40 is positioned proximate a forward end of the second towed vehicle 16, along the longitudinal axis 26 and along the second pivot axis 20. It is noted that the first, second and third sensors 36, 38, 40 may be placed in alternative positions with respect to the vehicles 12, 14, 16 if calibrated and/or programmed accordingly. The first sensor 36 includes a first global positioning system receiver and is configured to sense a relative orientation of the longitudinal axis 22 of the towing vehicle 12 within an associated global coordinate system. Likewise, the second sensor 38 includes a second global positioning system receiver 44 and is configured to sense a relative orientation of the longitudinal axis 24 of the second towed vehicle 16 within the global coordinate system, while the third sensor 40 includes a third global positioning receiver 46 and is configured to sense a relative orientation of the longitudinal axis 26 of the second towed vehicle 16 within the global coordinate system. The first, second and third sensors 36, 38, 40 are coupled for communication with a controller 48. The sensors 36, 38, 40 may either be hardwired to the controller 48 via electrical and communication line connections between the towing vehicle 12 and the towed vehicles 14, 16, or may communicate therewith via a wireless communication system.

The controller 48 is configured to calculate an angular offset a between the longitudinal axis 22 of the towing vehicle 12 and a longitudinal axis 24 of the first towed vehicle 14 in a lateral direction, and the angular offset p between the longitudinal axis 24 of the first towed vehicle 14 and the longitudinal axis 26 of the second towed vehicle 16 in a lateral direction. Alternatively, the relative orientation of the axes 22, 24, 26 within the global coordinate system may be utilized by the controller 48 to calculate an angular offset between the longitudinal axis 22 of the towing vehicle 12 and the longitudinal axis 24 of the first towed vehicle 14 in a substantially vertical orientation or plane, and an angular offset between the longitudinal axis 24 of the first towed vehicle 14 and the longitudinal axis 26 of the second towed vehicle 16 in a substantially vertical orientation or plane, thereby allowing calculation of the pitch angle between the towing vehicle 12 and the first towed vehicle 14 and between the first towed vehicle 14 and the second towed vehicle 16. The angular offsets as calculated by the controller 48 may be utilized to determine forces exchanged between the vehicles 12, 14, 16 for dynamic vehicle control, dynamic modeling, and accident reconstruction, for autonomous vehicle operation in both the forward and rearward directions, for dynamic control of suspension and braking assemblies of the vehicles 12, 14, 16, and the like.

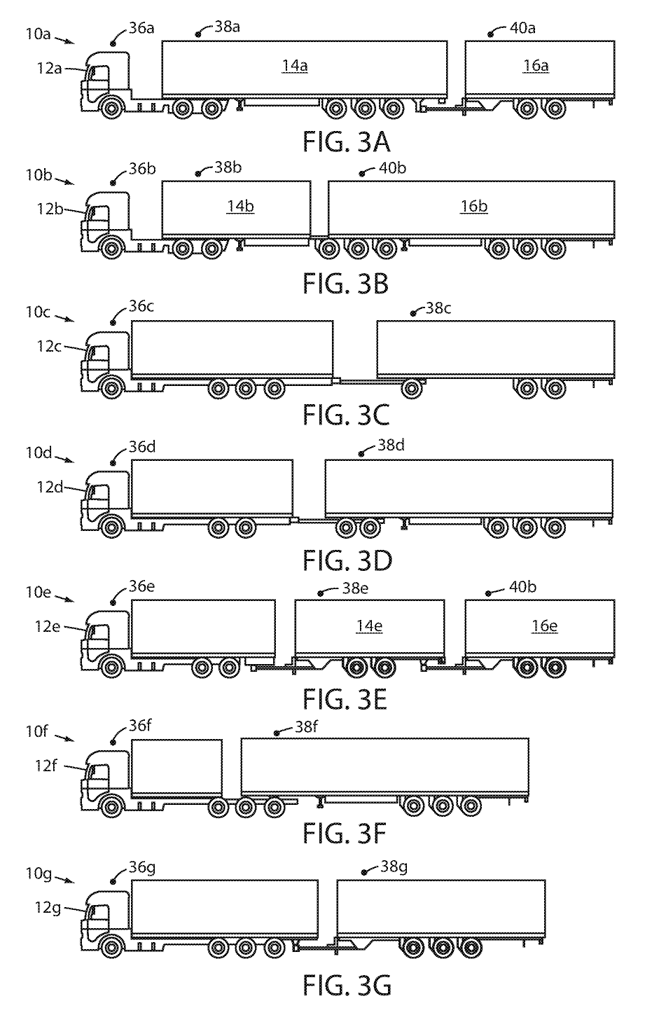

As illustrated in FIGS. 3A-3G, the controller arrangement as described herein may be utilized within variously configured vehicle systems, wherein the vehicle systems include single or multiple towed vehicles. Since the vehicle systems as illustrated in FIGS. 3A-3G are similar to the vehicle system as previously described and as shown in FIGS. 1 and 2, similar parts appearing in FIGS. 1 and 2 and in FIGS. 3A-3G are represented by the same, corresponding reference numeral except for the suffix “a”-“g,” respectively, in the numerals of the latter.

The present inventive vehicle system provides an accurate and reliable system for monitoring the relative positions between a towing and a towed vehicle allowing for calculation of forces exchanged between the vehicles, dynamic modeling and accident reconstruction, autonomous vehicle operation in both forward and rearward directions, and for dynamic control of suspension and braking units associated with the vehicles.

In the foregoing discussion, it will be readily appreciated by those skilled in the art that modifications may be made to the embodiments as disclosed herein without departing from the concepts as disclosed herein. Such modifications are to be considered as included in the following claims, unless these claims by their language expressly state otherwise.

The invention claimed is:

1. A vehicle system, comprising:
a first vehicle having a first longitudinal axis;
a second vehicle operably coupled with the first vehicle and having a second longitudinal axis, wherein the second longitudinal axis of the second vehicle is movable between a first position where the second axis is aligned with the first axis and a second position where the second axis is angularly offset from the first axis; and
a controller arrangement, comprising:
a sensor arrangement, comprising:
a first sensor connected with the first vehicle and operably coupled with the receiver, the first sensor includes a first global positioning system receiver and is configured to sense a relative orientation of the first longitudinal axis within a global coordinate system; and
a second sensor connected with the second vehicle and operably coupled with the receiver, the second sensor includes a second global positioning system receiver and is configured to sense a relative orientation of the second longitudinal axis within a global coordinate system; and
a controller operably coupled the first sensor and the second sensor, wherein the controller is configured to calculate an angular offset between the first and second longitudinal axes.

2. The vehicle system of claim 1, wherein the first vehicle includes a towing vehicle and the second vehicle includes towed vehicle.

3. The vehicle system of claim 1, wherein the towing vehicle includes a semi-tractor.

4. The vehicle system of claim 3, wherein the towed vehicle includes a semi-trailer.

5. The vehicle system of claim 1, wherein the second sensor is coupled to the second vehicle proximate a front end of the second vehicle.

6. The vehicle system of claim 1, wherein the first sensor is located along the first longitudinal axis.

7. The vehicle system of claim 1, wherein the second sensor is located along the second longitudinal axis.

8. The vehicle system of claim 1, wherein the angular offset is in a substantially lateral direction.

9. The vehicle system of claim 1, wherein the controller is located within the first vehicle.

10. The vehicle system of claim 1, further comprising:
a third vehicle operably coupled with the second vehicle and having a third longitudinal axis, wherein the third longitudinal axis of the third vehicle is movable between a first position where the third axis is aligned with the second axis and a second position where the third axis is angularly offset from the second axis, wherein the sensor arrangement further comprises a third sensor connected with the third vehicle and operably coupled with the receiver, the third sensor includes a third global positioning system receiver and is configured to sense a relative orientation of the third longitudinal axis within the global coordinate system, and wherein the controller is configured to calculate an angular offset between the second and third longitudinal axes.

11. The vehicle system of claim 10, wherein the angular offset between the second and third axes is in the substantially lateral direction.

12. The vehicle system of claim 1, wherein the second vehicle is pivotably coupled with the first vehicle.

13. The vehicle system of claim 12, wherein the second sensor is located along a pivot axis of a pivot coupling between the first and second vehicles.

14. A vehicle system, comprising:
a towing vehicle having a first longitudinal axis;
a first towed vehicle pivotably coupled with the towing vehicle and having a second longitudinal axis, wherein the second longitudinal axis of the first towed vehicle is movable between a first position where the second axis is aligned with the first axis and a second position where the second axis is angularly offset from the first axis; and
a controller arrangement, comprising:
a sensor arrangement, comprising:
a first sensor connected with the towing vehicle and operably coupled with the receiver, the first sensor includes a first global positioning system receiver and is configured to sense a relative orientation of the first longitudinal axis within a global coordinate system; and
a second sensor connected with the first towed vehicle and operably coupled with the receiver, the second sensor incudes a second global positioning system receiver and is configured to sense a relative orientation of the second longitudinal axis within a global coordinate system; and
a controller operably coupled with the first sensor and the second sensor, wherein the controller is configured to calculate an angular offset between the first and second longitudinal axes in a substantially lateral direction.

15. The vehicle system of claim 14, wherein the towing vehicle includes a semi-tractor.

16. The vehicle system of claim 15, wherein the towing vehicle includes a semi-trailer.

17. The vehicle system of claim 14, wherein the second sensor is coupled to the first towed vehicle proximate a front end of the first towed vehicle.

18. The vehicle system of claim 14, wherein the first sensor is located along the first longitudinal axis.

19. The vehicle system of claim 14, wherein the second sensor is located along the second longitudinal axis.

20. The vehicle system of claim 14, wherein the controller located within the towing vehicle.

21. The vehicle system of claim 20, wherein the angular offset between the second and third axes is in the substantially lateral direction.

22. The vehicle system of claim 14, wherein the second sensor is located along a pivot axis of a pivot coupling between the first and second vehicles.

23. A method for controlling vehicle system, comprising:
providing a first vehicle having a first longitudinal axis;
providing a second vehicle operably coupled with the first vehicle and having a second longitudinal axis, wherein the second longitudinal axis of the second vehicle is movable between a first position where the second axis is aligned with the first axis and a second position where the second axis is angularly offset from the first axis; and
providing a controller arrangement that includes a sensor arrangement that includes a first sensor connected with the first vehicle and operably coupled with the receiver, the first sensor includes a first global positioning system receiver and is configured to sense a relative orientation of the first longitudinal axis within a global coordinate system, and a second sensor connected with the second vehicle and operably coupled with the receiver, the second sensor includes a second global positioning system receiver and is configured to sense a relative orientation of the second longitudinal axis within a global coordinate system, and a controller operably coupled with the first sensor and the second sensor, wherein the controller is configured to calculate an angular offset between the first and second longitudinal axes;
operating the first vehicle such that the first longitudinal axis is angularly offset from the second longitudinal axis;
sensing the orientation of the first longitudinal axis within the global coordinate system;
communicating the orientation of the first longitudinal axis with the controller;
sensing the orientation of the second longitudinal axis within the global coordinate system;
communicating the orientation of second longitudinal axis with the controller; and
calculating the angular offset between the first and second axes with the controller.

24. The method of claim 23, wherein the first vehicle includes a towing vehicle and the second vehicle includes towed vehicle.

25. The method of claim 23, wherein the towing vehicle includes a semi-tractor.

26. The method of claim 25, wherein the towed vehicle includes a semi-trailer.

27. The method of claim 23, wherein the second sensor is coupled to the second vehicle proximate a front end of the second vehicle.

28. The method of claim 23, wherein the first sensor is located along the first longitudinal axis.

29. The method of claim 23, wherein the second sensor is located along the second longitudinal axis.

30. The method of claim 23, wherein the angular offset is in a substantially lateral direction.

31. The method of claim 23, wherein the controller is located within the first vehicle.
